(19) United States
(12) Patent Application Publication
(10) Pub. No.: US 2015/0225526 A1
(43) Pub. Date: Aug. 13, 2015

(54) CROSSLINKED FOAMS HAVING HIGH HARDNESS AND LOW COMPRESSION SET

(71) Applicants: Huichin Tu, Taipei (CN); Lei Hao, Shanghai (CN); Xiaobing Yun, Beijing (CN); Chang Wu, Shanghai (CN)

(72) Inventors: Huichin Tu, Taipei (CN); Lei Hao, Shanghai (CN); Xiaobing Yun, Beijing (CN); Chang Wu, Shanghai (CN)

(73) Assignee: DOW GLOBAL TECHNOLOGIES LLC, Midland, MI (US)

(21) Appl. No.: 14/405,305

(22) PCT Filed: Jun. 28, 2012
(86) PCT No.: PCT/CN2012/077782

§ 371 Date: May 1, 2015

(51) Int. Cl. C08J 9/00; C08L 23/08; C08L 31/04; C08F 210/16

(52) U.S. Cl. CPC C08J 9/0028; C08F 210/16; C08L 23/08; C08L 31/04; C08J 2323/08; C08J 2323/20

(57) ABSTRACT

A foamable formulation composition comprises at least 50 weight percent of an ethylene/α-olefin interpolymer having a Comonomer Distribution Constant in the range of from 15 to 250; a density in the range of from 0.875 to 0.963 g/cm³; a melt index (I₂) in a range of from 0.5 to 5 g/10 minutes; and long chain branching frequency in the range of from 0.05 to 3 long chain branches (LCB) per 1000 C; (2) a blowing agent; and (3) a cross link agent. The formulation may be processed to result in a foam having a density ranging from 0.05 to 0.25 g/cm³ and have properties such as split tear, compression set, and/or shrinkage percentage that are improved in comparison with otherwise-identical formulations lacking the identified ethylene/α-olefin interpolymer in comparable amount. These foams may be particularly useful for a variety of applications, including, in particular, footwear applications.

### BACKGROUND

1. Field of the Invention

The invention relates to the field of foams, foaming compositions, and applications thereof. More specifically, the invention relates to foams having high hardness and enhanced compression set.

2. Background of the Art

Crosslinked foams have a low specific gravity, i.e., are lightweight, and exhibit both flexibility and mechanical strength. They have been widely used for interior and exterior materials in construction, automotive applications such as for interior materials and door glass run channels, packing materials, and daily necessities. Merely foaming a resin provides light weight, but often results in a foam having low mechanical strength. In order to counter this problem, researchers in the art have discovered that crosslinking the molecular chains in the foam increases the mechanical strength.

Crosslinked foams made of resin find use in footwear and footwear components such as shoe soles (mainly mid soles) of, for example, sport shoes. This is because footwear and footwear components are required to meet conditions such as light weight, resistance to deformation by long use, and mechanical strength and impact resilience to withstand use under severe conditions.

Researchers have sought formulations for making such footwear components, in particular, as well as other articles with similar requirements using a wide variety of materials, including in particular olefin polymers such as ethylene/vinyl acetate (EVA) copolymers. However, because EVA is currently expensive due to a shortage thereof, alternative formulations are sought.

Alternatives currently represented in the art include, in non-limiting example, US Publication 20090126234A1 (Mitsui), which discloses foams prepared by foaming an olefin polymer, the foam having a specific gravity (d) from 0.03 to 0.30. The foam's compression set (CS, %) and specific gravity are related by the formula CS≦−279×(d)+95. The foam composition includes an ethylene polymer having an ethylene/α-olefin copolymer and an ethylene/polar monomer copolymer in a specific mass ratio, and a specific ethylene/C3-20 α-olefin/non-conjugated polyene copolymer.

In view of the limitations and/or expense encountered with other known formulations, researchers continue to search for formulations that can be used to optimize mechanical strength, and impact resilience, and that also offer low density, for footwear, and other, applications.

### SUMMARY OF THE INVENTION

In one aspect the present invention provides a foamable formulation composition comprising (1) at least 50 weight percent (wt %), based on the formulation as a whole, of an ethylene/α-olefin interpolymer composition (LLDPE) having a Comonomer Distribution Constant (CDC) ranging from 75 to 200, a vinyl unsaturation of less than 0.15 vinyls per one thousand carbon atoms present in the backbone of the ethylene-based polymer composition; a zero shear viscosity ratio (ZSVR) ranging from 2 to 20; a density ranging from 0.903 to 0.950 g/cm³; a melt index (I₂) ranging from 0.1 to 5 g/10 minutes; and a molecular weight distribution (M_{w}/Mₙ) ranging from 1.8 to 3.5.

In another aspect the present invention provides a process for preparing a foamed composition comprising preparing the above-described foamable formulation composition, and subjecting it to conditions such that a foamed composition is formed.

In yet another aspect the present invention provides the foam composition prepared from the above-described foamable formulation composition, the foam composition having a property selected from the group consisting of compression set, according to ASTM D395; split tear, according to BS 5131; shrinkage percentage; and combinations thereof; that is lower, with respect to compression set or shrinkage, or higher, with respect to split tear strength, when compared with that of a foam that is prepared from an otherwise identical formulation that lacks the at least 50 weight percent, based on the formulation as a whole, of the ethylene/α-olefin interpolymer. In some embodiments the foam composition has a density ranging from 0.05 to 0.25 grams per cubic centimeter (g/cm³).

### DETAILED DESCRIPTION OF THE EMBODIMENTS

The inventive foamable formulations offer a convenient and frequently less expensive means to prepare polymeric foams having desirable properties such as compression set, tear strength, hardness, and density.

### Ethylene/α-Olefin Interpolymer Composition

A basis of the composition is, first, inclusion of an ethylene/α-olefin interpolymer composition (LLDPE) having a Comonomer Distribution Constant (CDC) in the range of from 75 to 200, a vinyl unsaturation of less than 0.15 vinyls per one thousand carbon atoms present in the backbone of the ethylene-based polymer composition; a zero shear viscosity ratio (ZSVR) in the range from 2 to 20; a density in the range of from 0.903 to 0.950 g/cm³, a melt index (I₂) in a range of from 0.1 to 5 g/10 minutes, a molecular weight distribution (M_{w}/Mₙ) in the range of from 1.8 to 3.5.

The ethylene/α-olefin interpolymer composition (linear low density polyethylene (LLDPE)) comprises (a) less than or equal to 100 percent, for example, at least 70 percent, or at least 80 percent, or at least 90 percent, by weight of the units derived from ethylene; and (b) less than 30 percent, for example, less than 25 percent, or less than 20 percent, or less than 10 percent, by weight of units derived from one or more α-olefin comonomers. The term “ethylene/α-olefin interpolymer composition” refers to a polymer that contains more than 50 mole percent polymerized ethylene monomer (based on the total amount of polymerizable monomers) and, optionally, may contain at least one comonomer.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

The ethylene/α-olefin interpolymer composition is characterized by having a Comonomer Distribution Constant in the range of from greater than from 45 to 400, for example from 75 to 300, or from 75 to 200, or from 85 to 150, or from 85 to 125. In one embodiment, ethylene/α-olefin interpolymer composition has a comonomer distribution profile comprising a monomodal distribution or a bimodal distribution in the temperature range of from 35° C. to 120° C., excluding purge.

The ethylene-based polymer composition is also characterized by having a zero shear viscosity ratio (ZSVR) in the range of from 2 to 20, for example, from 2 to 10, or from 2 to 6, or from 2.5 to 4.

The ethylene/α-olefin interpolymer composition also has a density in the range of 0.903 to 0.950 g/cm³. For example, the density can be from a lower limit of 0.903, 0.905, 0.908, 0.910, or 0.912 g/cm³ to an upper limit of 0.925, 0.935, 0.940, 0.945, 0.950 g/cm³.

The ethylene/α-olefin interpolymer composition has a molecular weight distribution (M_{w}/Mₙ) in the range of from 1.8 to 3.5. For example, the molecular weight distribution (M_{w}/Mₙ) can be from a lower limit of 1.8, 2, 2.1, or 2.2 to an upper limit of 2.5, 2.7, 2.9, 3.2, or 3.5.

The ethylene/α-olefin interpolymer composition has a melt index (I₂) in the range of 0.1 to 5 g/10 minutes. For example, the melt index (I₂) can be from a lower limit of 0.1, 0.2, 0.5, or 0.8 g/10 minutes to an upper limit of 1.2, 1.5, 1.8, 2.0, 2.2, 2.5, 3.0, 4.0, 4.5 or 5.0 g/10 minutes.

The ethylene/α-olefin interpolymer composition has a molecular weight (M_{w}) in the range of 50,000 to 250,000 daltons. For example, the molecular weight (M_{w}) can be from a lower limit of 50,000, 60,000, 70,000 daltons to an upper limit of 150,000, 180,000, 200,000 or 250,000 daltons.

The ethylene/α-olefin interpolymer composition has a molecular weight distribution (M_{z}/M_{w}) in the range of less than 4, for example, less than 3, or from 2 to 2.8.

The ethylene/α-olefin interpolymer composition has a vinyl unsaturation of less than 0.15 vinyls per one thousand carbon atoms present in the backbone of the ethylene-based polymer composition.

The ethylene/α-olefin interpolymer composition has a long chain branching frequency in the range of from 0.02 to 3 long chain branches (LCB) per 1000 C

In one embodiment, the ethylene/α-olefin interpolymer composition comprises less than or equal to 100 parts, for example, less than 10 parts, less than 8 parts, less than 5 parts, less than 4 parts, less than 1 parts, less than 0.5 parts, or less than 0.1 parts, by weight of metal complex residues remaining from a catalyst system comprising a metal complex of a polyvalent aryloxyether per one million parts of the ethylene-based polymer composition. The metal complex residues remaining from the catalyst system comprising a metal complex of a polyvalent aryloxyether in the ethylene-based polymer composition may be measured by x-ray fluorescence (XRF), which is calibrated to reference standards. The polymer resin granules can be compression molded at elevated temperature into plaques having a thickness of about 3/8 of an inch for the x-ray measurement in a preferred method. At very low concentrations of metal complex, such as below 0.1 ppm, ICP-AES would be a suitable method to determine metal complex residues present in the ethylene-based polymer composition.

In addition to the at least 50 wt % of the ethylene/α-olefin material described and defined hereinabove, the formulations of the present invention may comprise other polymers, and in particular, polar polymers. Preferably the combination of the ethylene/α-olefin polymer and any additional polar or non-polar polymer is at least 80 wt % of the total polymer, and more preferably at least 90 wt %, with the additional polar polymer alone being up to 50 wt %, desirably up to 30 wt %, and more desirably 20 to 30 wt %, and non-polar polymers being preferably in much smaller amount, for example, less than 10 wt % and more desirably less than 5 wt %. Such polar polymers may include, in non-limiting example, polar polymers such as poly(styrene-ethylene/butylene-styrene) (SEBS) polymers; poly(styrene-butadiene-styrene) (SBS) polymers; poly(styrene-ethylene/propylene-styrene) (SEPS) polymers; ethylene-butene copolymers; ethylene-octene copolymers; ethylene-hexene copolymers; ethylene-propylene-rubber (EPR) polymers; ethylene-propylene-diene-monomer (EPDM) polymers; ethylene vinyl acetate (EVA) polymers; propylene-ethylene copolymers; and other polar materials such as ethylene co-acrylic acid (EAA) polymers; ethylene acetate (EEA) polymers; ethylene methacrylate (EMA) polymers; ethylene-bis-stearamide (EBS) polymers; and combinations thereof. Additional useful polymers may include polyolefin elastomer (POE) polymers; polyethylene/ethylene copolymers; other LLDPE resins; and combinations thereof may also be included in the formulation. Non-polar polymers, such as linear low density polyethylene (LDPE), may be included in the formulation, in particularly because they may be useful to decrease the total formulation cost.

### Additives

The formulations of the invention may further comprise one or more additives. Such additives include, but are not limited to, anti-static agents, color enhancers, dyes, lubricants, fillers, pigments, opacifiers, anti-blocks, slip agents, tackifiers, antimicrobial agents, fire retardants, anti-fungals, odor reducing agents, primary antioxidants, secondary antioxidants, processing aids, UV stabilizers, so-called “kickers,” nucleation agents, and combinations thereof. The ethylene-based polymer composition may contain from about 0.1 to about 20 percent by the combined weight of such additives, based on the combined weight of the ethylene-based polymer composition including all such additives.

At least one blowing agent is also included as a part of the formulation, and may be selected from azo compounds, such as, for example, azobisformamide, and are preferably combined with nucleation agents, such as calcium carbonate, and blowing agent activators, such as zinc oxide. Those skilled in the art will be familiar with a wide variety of formulation variables envisioned within the scope of the present invention.

In order to prepare the foams of the invention, having improved physical properties such as compression set values and tear strength, a cross link agent, or a combination thereof, is also desirably included in the formulation. Such may be employed for purposes of either fully or partially cross-linking the ethylenic interpolymer. Some suitable cross-linking agents are disclosed in Zweifel Hans et al., “Plastics Additives Handbook,” Hanser Gardner Publications, Cincinnati, Ohio, 5th edition, Chapter 14, pages 725-812 (2001); Encyclopedia of Chemical Technology, Vol. 17, 2nd edition, Interscience Publishers (1968); and Daniel Seern, “Organic Peroxides,” Vol. 1, Wiley-Interscience, (1970). Non-limiting examples of suitable cross-linking agents include peroxides, phenols, azides, aldehyde-amine reaction products, substituted ureas, substituted guanidines; substituted xanthates; substituted dithiocarbamates; sulfur-containing compounds, such as thiazoles, sulfenamides, thiuramidisulfides, paraquinonedioxime, dibenzoparaquinonedioxime, sulfur; imidazoles; silanes and combinations thereof. Non-limiting examples of suitable organic peroxide cross-linking agents include alkyl peroxides, aryl peroxides, peroxyesters, peroxycarbonates, diacylperoxides, peroxyketals, cyclic peroxides and combinations thereof. In some embodiments, the organic peroxide is dicumyl peroxide, t-butylisopropylidene peroxybenzene, 1,1-di-t-butyl peroxy-3,3,5-trimethylcyclohexane, 2,5-dimethyl-2,5-di(t-butyl peroxy) hexane, t-butyl-cumyl peroxide, di-t-butyl peroxide, 2,5-dimethyl-2,5-di-(t-butyl peroxy) hexyne or a combination thereof. In one embodiment, the organic peroxide is dicumyl peroxide. Additional teachings regarding organic peroxide cross-linking agents are disclosed in C. P. Park, “Polyolefin Foam”, Chapter 9 of Handbook of Polymer Foams and Technology, edited by D. Klempner and K. C. Frisch, Hanser Publishers, pp. 198-204, Munich (1991). Non-limiting examples of suitable azide cross-linking agents include azidoformates, such as tetramethylenebis(azidoformate); aromatic polyazides, such as 4,4′-diphenylmethane diazide; and sulfonazides, such as p,p′-oxybis(benzene sulfonyl azide). The disclosure of azide cross-linking agents can be found in U.S. Pat. Nos. 3,284,421 and 3,297,674. In some embodiments, the cross-linking agents are silanes. Any silane that can effectively graft to and/or cross-link the ethylene/α-olefin interpolymer or the polymer blend disclosed herein can be used. Non-limiting examples of suitable silane cross-linking agents include unsaturated silanes that comprise an ethylenically unsaturated hydrocarbyl group, such as a vinyl, allyl, isopropenyl, butenyl, cyclohexenyl or gamma-(meth)acryloxy allyl group, and a hydrolyzable group such as a hydrocarbyloxy, hydrocarbonyloxy, and hydrocarbylamino group. Non-limiting examples of suitable hydrolyzable groups include methoxy, ethoxy, formyloxy, acetoxy, proprionyloxy, alkyl and arylamino groups. In other embodiments, the silanes are the unsaturated alkoxy silanes which can be grafted onto the interpolymer. Some of these silanes and their preparation methods are more fully described in U.S. Pat. No. 5,266,627. The amount of the cross-linking agent can vary widely, depending upon the nature of the ethylenic polymer or the polymeric composition to be cross-linked, the particular cross-linking agent employed, the processing conditions, the amount of grafting initiator, the ultimate application, and other factors. For example, when vinyltrimethoxysilane (VTMOS) is used, the amount of VTMOS is generally at least about 0.1 weight percent, at least about 0.5 weight percent, or at least about 1 weight percent, based on the combined weight of the cross-linking agent and the ethylenic polymer or the polymeric composition.

Any conventional ethylene (co)polymerization reaction processes may be employed to produce the ethylene-based polymer composition. Such conventional ethylene (co)polymerization reaction processes include, but are not limited to, gas phase polymerization process, slurry phase polymerization process, solution phase polymerization process, and combinations thereof using one or more conventional reactors, e.g. fluidized bed gas phase reactors, loop reactors, stirred tank reactors, batch reactors in parallel, series, and/or any combinations thereof.

In one embodiment, the ethylene/α-olefin interpolymer composition is prepared via a process comprising the steps of: (a) polymerizing ethylene and optionally one or more α-olefins in the presence of a first catalyst to form a semi-crystalline ethylene-based polymer in a first reactor or a first part of a multi-part reactor; and (b) reacting freshly supplied ethylene and optionally one or more α-olefins in the presence of a second catalyst comprising an organometallic catalyst thereby forming an ethylene/α-olefin interpolymer composition in at least one other reactor or a later part of a multi-part reactor, wherein at least one of the catalyst systems in step (a) or (b) comprises a metal complex of a polyvalent aryloxyether corresponding to the formula:

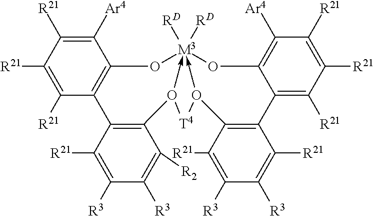

wherein M³ is Ti, Hf or Zr, preferably Zr;

Ar⁴ is independently in each occurrence a substituted C₉₋₂₀ aryl group, wherein the substituents, independently in each occurrence, are selected from the group consisting of alkyl; cycloalkyl; and aryl groups; and halo-, trihydrocarbylsilyl- and halohydrocarbyl-, or two R³ groups on the same arylene ring together or an R³ and an R²¹ group on the same or different arylene ring together form a divalent ligand group attached to the arylene group in two positions or join two different arylene rings together; and substituted derivatives thereof, with the proviso that at least one substituent lacks co-planarity with the aryl group to which it is attached;

T⁴ is independently in each occurrence a C₂₋₂₀ alkylene, cycloalkylene or cycloalkenylene group, or an inertly substituted derivative thereof;

R²¹ is independently in each occurrence hydrogen, halo, hydrocarbyl, trihydrocarbylsilyl, trihydrocarbylsilylhydrocarbyl, alkoxy or di(hydrocarbyl)amino group of up to 50 atoms not counting hydrogen;

R³ is independently in each occurrence hydrogen, halo, hydrocarbyl, trihydrocarbylsilyl, trihydrocarbylsilylhydrocarbyl, alkoxy or amino of up to 50 atoms not counting hydrogen

R^{D} is independently in each occurrence halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

The ethylene/α-olefin interpolymer composition may be produced via a solution polymerization according to the following exemplary process.

All raw materials (ethylene, 1-octene) and the process solvent (a narrow boiling range high-purity isoparaffinic solvent commercially available under the tradename Isopar E from ExxonMobil Corporation) are purified with molecular sieves before introduction into the reaction environment. Hydrogen is supplied in pressurized cylinders as a high purity grade and is not further purified. The reactor monomer feed (ethylene) stream is pressurized via mechanical compressor to a pressure that is above the reaction pressure, approximate to 750 psig (pounds per square inch gauge, equal to about 5272 kilopascals, kPa). The solvent and comonomer (1-octene) feed is pressurized via mechanical positive displacement pump to a pressure that is above the reaction pressure, approximately 750 psig. The individual catalyst components are manually batch diluted to specified component concentrations with purified solvent (Isopar E) and pressurized to a pressure that is above the reaction pressure, approximately 750 psig (about 5272 kPa). All reaction feed flows are measured with mass flow meters, independently controlled with computer automated valve control systems.

The continuous solution polymerization reactor system may consist of two liquid full, non-adiabatic, isothermal, circulating, and independently controlled loops operating in a series configuration. Each reactor has independent control of all fresh solvent, monomer, comonomer, hydrogen, and catalyst component feeds. The combined solvent, monomer, comonomer and hydrogen feed to each reactor is independently temperature controlled to anywhere between 5° C. to 50° C. and typically 40° C. by passing the feed stream through a heat exchanger. The fresh comonomer feed to the polymerization reactors can be manually aligned to add comonomer to one of three choices: the first reactor, the second reactor, or the common solvent and then split between both reactors proportionate to the solvent feed split. The total fresh feed to each polymerization reactor is injected into the reactor at two locations per reactor roughly with equal reactor volumes between each injection location. The fresh feed is controlled typically with each injector receiving half of the total fresh feed mass flow. The catalyst components are injected into the polymerization reactor through specially designed injection stingers and are each separately injected into the same relative location in the reactor with no contact time prior to the reactor. The primary catalyst component feed is computer controlled to maintain the reactor monomer concentration at a specified target. The two cocatalyst components are fed based on calculated specified molar ratios to the primary catalyst component. Immediately following each fresh injection location (either feed or catalyst), the feed streams are mixed with the circulating polymerization reactor contents with static mixing elements. The contents of each reactor are continuously circulated through heat exchangers responsible for removing much of the heat of reaction and with the temperature of the coolant side responsible for maintaining isothermal reaction environment at the specified temperature. Circulation around each reactor loop is provided by a screw pump. The effluent from the first polymerization reactor (containing solvent, monomer, comonomer, hydrogen, catalyst components, and molten polymer) exits the first reactor loop and passes through a control valve (responsible for maintaining the pressure of the first reactor at a specified target) and is injected into the second polymerization reactor of similar design. As the stream exits the reactor, it is contacted with a deactivating agent, e.g. water, to stop the reaction. In addition, various additives such as anti-oxidants, can be added at this point. The stream then goes through another set of static mixing elements to evenly disperse the catalyst deactivating agent and additives.

Following additive addition, the effluent (containing solvent, monomer, comonomer, hydrogen, catalyst components, and molten polymer) passes through a heat exchanger to raise the stream temperature in preparation for separation of the polymer from the other lower boiling reaction components. The stream then enters a two stage separation and devolatilization system where the polymer is removed from the solvent, hydrogen, and unreacted monomer and comonomer. The recycled stream is purified before entering the reactor again. The separated and devolatized polymer melt is pumped through a die specially designed for underwater pelletization, cut into uniform solid pellets, dried, and transferred into a hopper.

The polymer or polymers and any desired additional additives may then be blended to prepare the foam, via any method known to a person of ordinary skill in the art including, but not limited to, dry blending, and melt blending via any suitable equipment, for example, as two-roll mill, to produce the foam formulation. Generally it is preferred that the blowing agent and crosslink agent being added last. Total mixing time may vary widely, but for commercial practicality is desirably from 10 to 20 minutes, and more desirably from 12 to 15 minutes. The formulation may then be processed appropriately according to whether a bun foam or a molded foam is being prepared. For example, for bun foaming the compound may be sheeted out at a thickness ranging from 1 to 10 millimeters, for example, about 5 mm, and then cut and weighed into a mold at a temperature ranging from 150° C. to 200° C., preferably 160° C. to 180° C. Where an in-mold foam is being made, the compound may be fed into a pelletizer once the formulation is fully homogeneous, and the pellets may then be melted and foamed in a mold.

### Foams

The formulation may be processed to result in a foam having a density ranging from 0.04 to 0.5 g/cm³, and improvements in other properties such as split tear, compression set, and shrinkage percentage, particularly in comparison with foams prepared from otherwise identical formulations and identical conditions but without the equivalent amount of the specified ethylene/α-olefin interpolymer. Such qualities may make the foams particularly desirable for footwear formulations, but a wide variety of other foam applications including but not limited to packaging, insulation, furnishings, sporting goods, and the like are also envisioned hereby.

### EXAMPLES

### Example 1

Two ways of preparing ethylene/α-olefin interpolymer materials useful in the inventive formulations are described as “Option 1” and “Option 2” hereinbelow:

In Option 1 the ethylene/α-olefin interpolymer used in the inventive formulations was prepared via a solution polymerization process in a dual reactor configuration connected in series in the presence of a catalyst system comprising a metal complex of a polyvalent aryloxyether, as described above, having a melt index (I₂) of approximately 0.91 g/10 minutes and a density of approximately 0.918 g/cm³, and further described in Table 1. The properties of the Inventive Composition 1 are measured, and reported in Table 2.

In Option 2 The ethylene-octene interpolymer was prepared via solution polymerization in a dual loop reactor system in the presence of a Zirconium based catalyst system comprising [2,2′″-[1,3-propanediylbis(oxy-κO)]bis[3″,5,5″-tris(1,1-dimethylethyl)-5′-methyl[1,1′:3′,1″-terphenyl]-2′-olato-κO]]dimethyl-, (OC-6-33)-Zirconium, represented by the following formula:

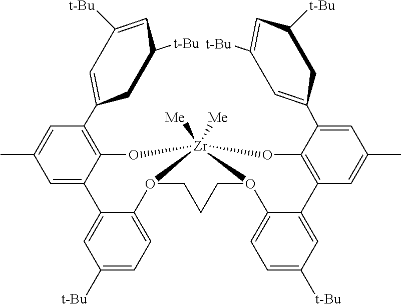

The polymerization conditions for Ethylene-octene interpolymer C is reported in Tables 2 and 3. Referring to Tables 2 and 3, MMAO is modified methyl aluminoxane; and RIBS-2 is bis(hydrogenated tallow alkyl)methyl, tetrakis(pentafluorophenyl)borate(1-)amine.

TABLE 1

| | Ethylene-Octene |
|---|---|
| Sample ID | Interpolymer C |
| Density (g/cm³) | 0.9029 |
| I₂ (g/10 minutes) | 0.9 |
| I₁₀/I₂ | 10.7 |

Unsaturation/1,000,000 C

| | |
|---|---|
| vinylene | 9 |
| trisubstitute | 2 |
| vinyl | 38 |
| vinylidene | 7 |
| Total unsaturation | 55 |

CEF

| | |
|---|---|
| Comonomer distribution Index | 0.911 |
| Stdev | 9.725 |
| Half width, C | 23.568 |
| Half width/Stdev | 2.423 |
| CDC(Comonomer Distribution Constant) | 37.6 |
| Wt % of Material eluting above 94.0° C. | 0.0% |

Conventional GPC

| | |
|---|---|
| Mₙ | 39079 |
| M_{w} | 93498 |
| M_{z} | 173835 |
| M_{w}/Mₙ | 2.4 |

Rheology

| | |
|---|---|
| Viscosity (Pa · s) | 13236 |
| Mw-GPC | 93498 |
| ZSVR | 4.2 |

DSC

| | |
|---|---|
| Tₘ (° C.) | 102.1 |
| Heat of fusion (J/g) | 109 |
| % Cryst. | 37.3% |

TABLE 2

| | | Ethylene-Octene |
|---|---|---|
| 1. REACTOR FEEDS | Unit | Interpolymer C |
| Primary Reactor Feed Temperature | ° C. | 35.02 |
| Primary Reactor Total Solvent Flow | lbs/hr | 1057.29 |
| Primary Reactor Fresh Ethylene Flow | lbs/hr | 183.75 |
| Primary Reactor Total Ethylene Flow | lbs/hr | 192.21 |
| Comonomer Type Used | | 1-octene |
| Primary Reactor Fresh Comonomer | lbs/hr | 67.04 |
| Flow | | |
| Primary Reactor Total Comonomer | lbs/hr | 104.08 |
| Flow | | |
| Primary Reactor Comonomer/Olefin | % | 35.11 |
| Ratio | | |
| Primary Reactor Feed Solvent/ | Ratio | 5.75 |
| Ethylene Ratio | | |
| Primary Reactor Fresh Hydrogen Flow | Standard | 2717 |
| | cm³/min | |
| Primary Reactor Hydrogen Mole | mol % | 0.2272 |
| Percent | | |
| Secondary Reactor Feed Temperature | ° C. | 34.55 |
| Secondary Reactor Total Solvent Flow | lbs/hr | 420.06 |
| Secondary Reactor Fresh Ethylene Flow | lbs/hr | 157.24 |
| Secondary Reactor Total Ethylene Flow | lbs/hr | 160.86 |
| Secondary Reactor Fresh Comonomer | lbs/hr | 0.00 |
| Flow | | |
| Secondary Reactor Total Comonomer | lbs/hr | 16.42 |
| Flow | | |
| Secondary Reactor Comonomer/Olefin | % | 9.24 |
| Ratio | | |
| Secondary Reactor Feed Solvent/ | Ratio | 2.67 |
| Ethylene Ratio | | |
| Secondary Reactor Fresh Hydrogen | Standard | 3029 |
| Flow | cm³/minute | |
| Secondary Reactor Hydrogen Mole | mol % | 0.2966 |
| Percent | | |
| Fresh Comonomer Injection | — | Secondary |
| Location | | Reactor |

TABLE 3

| | | Ethylene- |
|---|---|---|
| | Unit | Octene |
| 2. REACTION | | |
| Primary Reactor Control Temperature | ° C. | 150.02 |
| Primary Reactor Pressure | psig | 725.01 |
| Primary Reactor Ethylene Conversion | % | 94.87 |
| Primary Reactor Percent Solids | % | 20.16 |
| Primary Reactor Polymer Residence Time | hrs | 0.29 |
| Secondary Reactor Control Temperature | ° C. | 190.04 |
| Secondary Reactor Pressure | psig | 725.25 |
| Secondary Reactor Ethylene Conversion | % | 84.99 |
| Secondary Reactor Percent Solids | % | 23.64 |
| Secondary Reactor Polymer Residence | hrs | 0.11 |
| Time | | |
| Vent Ethylene Conversion | % | 92.66 |
| Primary Reactor Split | % | 58.33 |
| 3. CATALYST | | |
| Primary Reactor Catalyst Type | — | Zirconium |
| | | Based |
| | | Catalyst |
| Primary Reactor Catalyst Flow | lbs/hr | 0.59 |
| Primary Reactor Catalyst Concentration | ppm | 54.71 |
| Primary Reactor Catalyst Efficiency | 10⁶ Lb | 7.76 |
| Primary Reactor Catalyst-1 Mole Weight | mw | 90.86 |
| Primary Reactor Co-Catalyst-1 Molar | Ratio | 3.07 |
| Ratio | | |
| Primary Reactor Co-Catalyst-1 Type | — | RIBS-2 |
| Primary Reactor Co-Catalyst-1 Flow | lbs/hr | 0.27 |
| Primary Reactor Co-Catalyst-1 | ppm | 4874.87 |
| Concentration | | |
| Primary Reactor Co-Catalyst-2 Molar | Ratio | 10.06 |
| Ratio | | |
| Primary Reactor Co-Catalyst-2 Type | — | MMAO |
| Primary Reactor Co-Catalyst-2 Flow | lbs/hr | 0.27 |
| Primary Reactor Co-Catalyst-2 | ppm | 359.47 |
| Concentration | | |
| Secondary Reactor Catalyst Type | — | Zirconium |
| | | Based |
| | | Catalyst |
| Secondary Reactor Catalyst Flow | lbs/hr | 3.22 |
| Secondary Reactor Catalyst Concentration | ppm | 54.71 |
| Secondary Reactor Catalyst Efficiency | 10⁶ Lb | 1.02 |
| Secondary Reactor Co-Catalyst-1 Molar | Ratio | 1.48 |
| Ratio | | |
| Secondary Reactor Co-Catalyst-1 Type | — | RIBS-2 |
| Secondary Reactor Co-Catalyst-1 Flow | lbs/hr | 0.71 |
| Secondary Reactor Co-Catalyst-1 | ppm | 4874.87 |
| Concentration | | |
| Secondary Reactor Co-Catalyst-2 Molar | Ratio | 9.88 |
| Ratio | | |
| Secondary Reactor Co-Catalyst-2 Type | — | MMAO-3A |
| Secondary Reactor Co-Catalyst-2 Flow | lbs/hr | 1.44 |
| Secondary Reactor Co-Catalyst-2 | ppm | 359.47 |
| Concentration | | |
| 4. POLYMER | | |
| GI200 Average Gel Area | mm²/24.6 cm³ | 1.46 |
| GI200 Std Dev Gel Area | mm²/24.6 cm³ | 2.99 |

### Testing:

In order to confirm the characterizing properties of the selected LLDPE polymer as described and defined hereinabove, testing using conventionally known means and methods may be carried out.

### Density

Determination of density may be carried out according to ASTM D-1928. Measurements are made within one hour of sample pressing using ASTM D-792, Method B.

### Melt Index

Melt index (I₂) may be measured in accordance with ASTM-D 1238, Condition 190° C./2.16 kg, and is reported in grams eluted per 10 minutes (g/10 min). Melt flow rate (I₁₀) is measured in accordance with ASTM-D 1238, Condition 190° C./10 kg, and is reported in grams eluted per 10 minutes (g/10 min).

### Thermal (Melting and Crystallization) Behavior

Differential Scanning Calorimetry (DSC) can be used to measure the melting and crystallization behavior of a polymer over a wide range of temperature. For example, the TA Instruments Q1000 DSC, equipped with an RCS (refrigerated cooling system) and an autosampler may be effectively used to perform this analysis. During testing, a nitrogen purge gas flow of 50 milliliters per minute (mL/mi)n is used. Each sample is melt pressed into a thin film at about 175° C.; the melted sample is then air-cooled to room temperature (˜25° C.). A 3-10 milligram (mg), 6 mm diameter specimen is extracted from the cooled polymer, weighed, placed in a light aluminum pan (ca. 50 mg), and crimped shut. Analysis is then performed to determine its thermal properties.

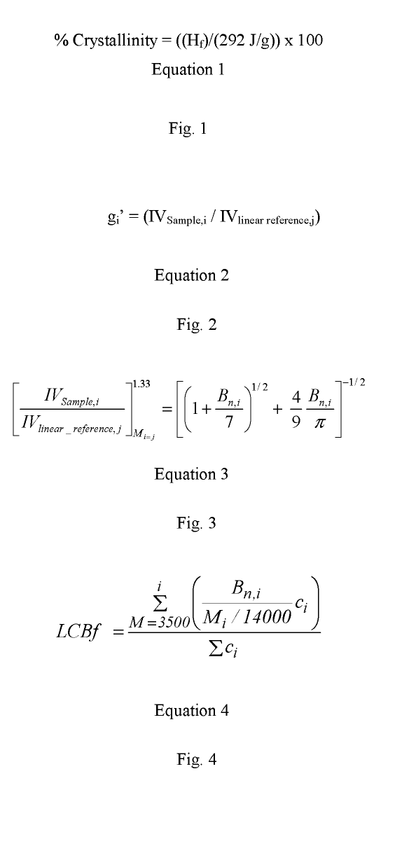

The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −40° C. at a 10° C./minute cooling rate and held isothermal at −40° C. for 3 minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tₘ), peak crystallization temperature (T_{c}), heat of fusion (H_{f}) (in Joules per gram, J/g), and the calculated % crystallinity for samples using appropriate equation, for example for the ethylene/alpha-olefin interpolymer using Equation 1, as shown in FIG. 1.

The heat of fusion (H_{f}) and the peak melting temperature are reported from the second heat curve. Peak crystallization temperature is determined from the cooling curve.

### Melt Rheology

Melt rheology, based on dynamic mechanical spectroscopy (DMS) frequency sweeps at constant temperature, may be performed using a TA Instruments Advanced Rheometric Expansion System (ARES) rheometer equipped with 25 mm parallel plates under a nitrogen purge. Frequency sweeps may be performed at 190° C. for all samples at a gap of 2.0 mm and at a constant strain of 10%. The frequency interval is from 0.1 to 100 radians/second (rad/s). The stress response is then analyzed in terms of amplitude and phase, from which the storage modulus (G′), loss modulus (G″), and dynamic melt viscosity (η*) are calculated.

### Molecular Weight

Gel permeation chromatography (GPC) may be used to test the ethylene/α-olefin interpolymers' properties, according to the following procedure. The GPC system consists of a Waters (Milford, Mass.) 150° C. high temperature chromatograph (other suitable high temperatures GPC instruments include Polymer Laboratories (Shropshire, UK) Model 210 and Model 220) equipped with an on-board differential refractometer (RI). Additional detectors can include an IR4 infra-red detector from Polymer ChAR (Valencia, Spain), Precision Detectors (Amherst, Mass.) 2-angle laser light scattering detector Model 2040, and a Viscotek (Houston, Tex.) 150R 4-capillary solution viscometer. A GPC with the last two independent detectors and at least one of the first detectors is sometimes referred to as “3D-GPC”, while the term “GPC” alone is generally referred to as a conventional GPC. Depending on the sample, either the 15-degree angle or the 90-degree angle of the light scattering detector is used for calculation purposes. Data collection is performed using Viscotek TriSEC software, Version 3, and a 4-channel Viscotek Data Manager DM400. The system may also be equipped with an on-line solvent degassing device from Polymer Laboratories (Shropshire, UK). Suitable high temperature GPC columns, such as four 30 cm long Shodex HT803 13 micron columns or four 30 cm Polymer Labs columns of 20-μm-mixed-pore-size packing (MixA LS, Polymer Labs), may also be used. The sample carousel compartment is operated at 140° C. and the column compartment is operated at 150° C. The samples are prepared at a concentration of 0.1 g polymer in 50 mL of solvent. The chromatographic solvent and the sample preparation solvent contain 200 ppm of butylated hydroxytoluene (BHT). Both solvents are sparged with nitrogen. The polyethylene samples are gently stirred at 160° C. for four hours. The injection volume is 200 microliters (μL). The flow rate through the GPC is set at 1 milliliter per minute (mL/min).

The GPC column set is calibrated before running the Examples by running twenty-one narrow molecular weight distribution polystyrene standards. The molecular weight (MW) of the standards ranges from 580 to 8,400,000 grams per mole (g/mol), and the standards are contained in 6 “cocktail” mixtures. Each standard mixture has at least a decade of separation between individual molecular weights. The standard mixtures are purchased from Polymer Laboratories (Shropshire, UK). The polystyrene standards are prepared at 0.025 g in 50 mL of solvent for molecular weights equal to or greater than 1,000,000 g/mol and 0.05 g in 50 mL of solvent for molecular weights less than 1,000,000 g/mol. The polystyrene standards are dissolved at 80° C. with gentle agitation for 30 minutes. The narrow standards mixtures are run first and in order of decreasing highest molecular weight component in order to minimize degradation. The polystyrene standard peak molecular weights are converted to polyethylene M_{w} using the Mark-Houwink K and a (sometimes referred to as α) values mentioned later for polystyrene and polyethylene.

With 3D-GPC, absolute weight average molecular weight (“M_{w, Abs}”) and intrinsic viscosity are also obtained independently from suitable narrow polyethylene standards using the same conditions mentioned previously. These narrow linear polyethylene standards may be obtained from Polymer Laboratories (Shropshire, UK; Part No.'s PL2650-0101 and PL2650-0102). The systematic approach for the determination of multi-detector offsets is performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)), optimizing triple detector log (M_{w} and intrinsic viscosity) results from Dow 1683 broad polystyrene (American Polymer Standards Corp.; Mentor, Ohio) or its equivalent to the narrow standard column calibration results from the narrow polystyrene standards calibration curve. The molecular weight data, accounting for detector volume off-set determination, are obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The overall injected concentration used in the determination of the molecular weight is obtained from the mass detector area and the mass detector constant derived from a suitable linear polyethylene homopolymer, or one of the polyethylene standards. The calculated molecular weights are obtained using a light scattering constant derived from one or more of the polyethylene standards mentioned and a refractive index concentration coefficient, do/dc, of 0.104. Generally, the mass detector response and the light scattering constant should be determined from a linear standard with a molecular weight in excess of about 50,000 daltons (Da). The viscometer calibration can be accomplished using the methods described by the manufacturer or alternatively by using the published values of suitable linear standards such as Standard Reference Materials (SRM) 1475a, 1482a, 1483, or 1484a. The chromatographic concentrations are assumed low enough to eliminate addressing 2^{nd} viral coefficient effects (concentration effects on molecular weight).

### Branching

The index (g′) for the sample polymer may be determined by 3D-GPC by first calibrating the light scattering, viscosity, and concentration detectors described in the Gel Permeation Chromatography method supra with SRM 1475a homopolymer polyethylene (or an equivalent reference). The light scattering and viscometer detector offsets are determined relative to the concentration detector as described in the calibration. Baselines are subtracted from the light scattering, viscometer, and concentration chromatograms and integration windows are then set, making certain to integrate all of the low molecular weight retention volume range in the light scattering and viscometer chromatograms that indicate the presence of detectable polymer from the refractive index chromatogram. A linear homopolymer polyethylene is used to establish a Mark-Houwink (MH) linear reference line by injecting a broad molecular weight polyethylene reference such as SRM1475a standard, calculating the data file, and recording the intrinsic viscosity (IV) and molecular weight (M_{w}), each derived from the light scattering and viscosity detectors respectively and the concentration as determined from the RI detector mass constant for each chromatographic slice. For the analysis of samples the procedure for each chromatographic slice is repeated to obtain a sample MH line. Note that for some samples the lower molecular weights, the intrinsic viscosity and the molecular weight data may need to be extrapolated such that the measured molecular weight and intrinsic viscosity asymptotically approach a linear homopolymer GPC calibration curve. To this end, many highly-branched ethylene-based polymer samples require that the linear reference line be shifted slightly to account for the contribution of short chain branching before proceeding with the long chain branching index (g′) calculation.

A g-prime (g₁′) is calculated for each branched sample chromatographic slice (i) and measuring molecular weight (Mᵢ) according to Equation 2, as shown in FIG. 2, where the calculation utilizes the IV_{linear reference,j} at equivalent molecular weight, Mⱼ, in the linear reference sample. In other words, the sample IV slice (i) and reference IV slice (j) have the same molecular weight (Mᵢ=Mⱼ). For simplicity, the IV_{linear reference,j} slices are calculated from a fifth-order polynomial fit of the reference Mark-Houwink Plot. The IV ratio, or gᵢ′, is only obtained at molecular weights greater than 3,500 because of signal-to-noise limitations in the light scattering data. The number of branches along the sample polymer (Bₙ) at each data slice (i) can be determined by using Equation 3, as shown in FIG. 3, assuming a viscosity shielding epsilon factor of 0.75.

Finally, the average LCBf quantity per 1000 carbons in the polymer across all of the slices (i) can be determined using Equation 4, as shown in FIG. 4. For purposes herein it is preferred (required?) that the average LCBf be from 0.05 to 3 long chain branches per 1000 C.

Additional determinations may be carried out to include, for example, determination of branching via a gpcBR Branching Index by 3D-GPC, as follows:

In the 3D-GPC configuration the polyethylene and polystyrene standards can be used to measure the Mark-Houwink constants, K and α, independently for each of the two polymer types, polystyrene and polyethylene. These can be used to refine the Williams and Ward polyethylene equivalent molecular weights in application of the following methods.

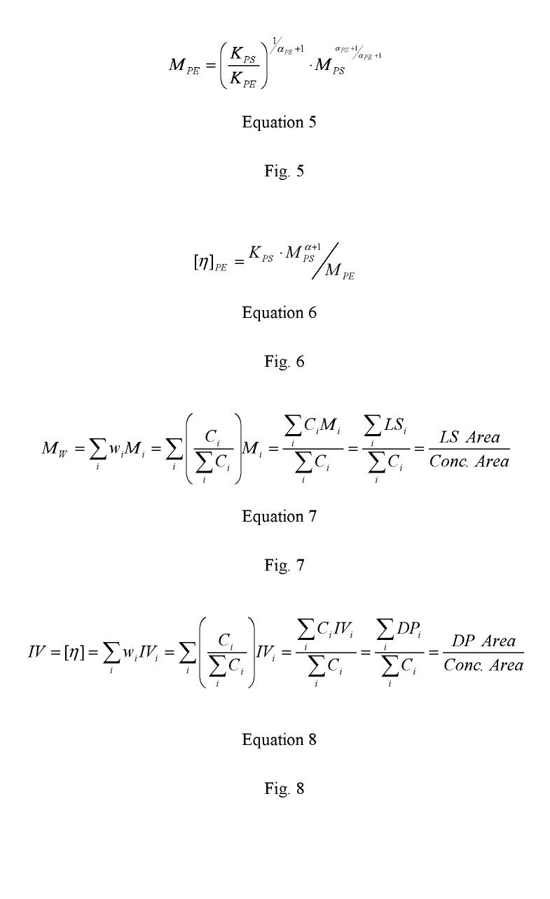

The gpcBR branching index is determined by first calibrating the light scattering, viscosity, and concentration detectors as described previously. Baselines are then subtracted from the light scattering, viscometer, and concentration chromatograms. Integration windows are then set to ensure integration of all of the low molecular weight retention volume range in the light scattering and viscometer chromatograms that indicate the presence of detectable polymer from the refractive index chromatogram. Linear polyethylene standards are then used to establish polyethylene and polystyrene Mark-Houwink constants as described previously. Upon obtaining the constants, the two values are used to construct two linear reference conventional calibrations (“cc”) for polyethylene molecular weight and polyethylene intrinsic viscosity as a function of elution volume, as shown in Equations 5 and 6, FIGS. 5 and 6, respectively.

The gpcBR branching index is a robust method for the characterization of long chain branching. See Yau, Wallace W., “Examples of Using 3D-GPC—TREF for Polyolefin Characterization”, Macromol. Symp., 2007, 257, 29-45. The index avoids the slice-by-slice 3D-GPC calculations traditionally used in the determination of g′ values and branching frequency calculations in favor of whole polymer detector areas and area dot products. From 3D-GPC data, the sample bulk M_{w} by the light scattering (LS) detector can be obtained using the peak area method. The method avoids the slice-by-slice ratio of light scattering detector signal over the concentration detector signal as required in the g′ determination.

The area calculation in Equation 7, shown in FIG. 7, offers more precision because as an overall sample area because it is much less sensitive to variation caused by detector noise and GPC settings on baseline and integration limits. More importantly, the peak area calculation is not affected by the detector volume offsets. Similarly, the high-precision sample intrinsic viscosity (IV) is obtained by the area method shown in Equation 8, as shown in FIG. 8, where DPᵢ stands for the differential pressure signal monitored directly from the online viscometer.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

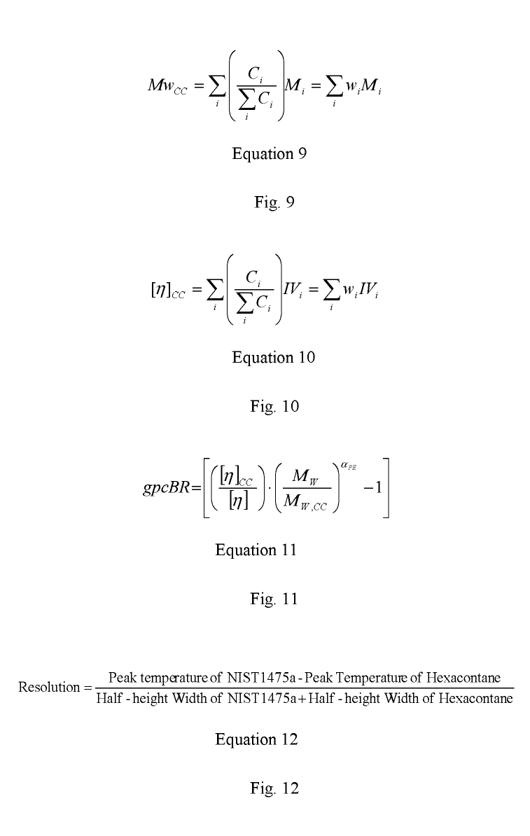

Initially, the molecular weight and intrinsic viscosity for a linear polyethylene standard sample, such as SRM1475a or an equivalent, are determined using the conventional calibrations for both molecular weight and intrinsic viscosity as a function of elution volume, per Equations 9 and 10, as shown in FIGS. 9 and 10, respectively.

Equation 11, as shown in FIG. 11, is used to determine the gpcBR branching index, where [η] is the measured intrinsic viscosity, [η]_{cc} is the intrinsic viscosity from the conventional calibration, M_{w} is the measured weight average molecular weight, and M_{w,cc} is the weight average molecular weight of the conventional calibration. The Mw by light scattering (LS) using Equation 7, as shown in FIG. 7, is commonly referred to as the absolute Mw; while the Mw,cc from Equation 9, as shown in FIG. 9, using the conventional GPC molecular weight calibration curve is often referred to as polymer chain Mw. All statistical values with the “cc” subscript are determined using their respective elution volumes, the corresponding conventional calibration as previously described, and the concentration (Cᵢ) derived from the mass detector response. The non-subscripted values are measured values based on the mass detector, LALLS, and viscometer areas. The value of K_{PE} is adjusted iteratively until the linear reference sample has a gpcBR measured value of zero. For example, the final values for a and Log K for the determination of gpcBR in this particular case are 0.725 and −3.355, respectively, for polyethylene, and 0.722 and −3.993 for polystyrene, respectively.

Once the K and α values have been determined, the procedure is repeated using the branched samples. The branched samples are analyzed using the final Mark-Houwink constants as the best “cc” calibration values and applying Equations 7-11, as shown in FIG. 7-11, respectively.

The interpretation of gpcBR is straightforward. For linear polymers, gpcBR calculated from Equation 11, as shown in FIG. 11, will be close to zero since the values measured by LS and viscometry will be close to the conventional calibration standard. For branched polymers, gpcBR will be higher than zero, especially with high levels of LCB, because the measured polymer M_{w} will be higher than the calculated M_{w,cc}, and the calculated IV_{cc} will be higher than the measured polymer Intrinsic Viscosity (IV). In fact, the gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight.

For these particular Examples, the advantage of using gpcBR in comparison to the g′ index and branching frequency calculations is due to the higher precision of gpcBR. All of the parameters used in the gpcBR index determination are obtained with good precision and are not detrimentally affected by the low 3D-GPC detector response at high molecular weight from the concentration detector. Errors in detector volume alignment also do not affect the precision of the gpcBR index determination. In other particular cases, other methods for determining M_{w} moments may be preferable to the aforementioned technique.

### Comonomer Distribution

The comonomer distribution analysis may be carried out using a Crystallization Elusion Fractionation (CEF) method (see B. Monrabal et al., Macromol. Symp. 257, 71-79 (2007), also called “PolymerChar” in Spain), as follows:

In this method 600 ppm antioxidant butylated hydroxytoluene (BHT) is used as the solvent. Sample preparation is done with autosampler at 160° C. for 2 hours under shaking at 4 mg/mL (unless otherwise specified). The injection volume is 300 μL. The temperature profile of CEF is: crystallization at 3° C./min from 110° C. to 30° C., the thermal equilibrium at 30° C. for 5 minutes, elution at 3° C./min from 30° C. to 140° C. The flow rate during crystallization is at 0.052 mL/min. The flow rate during elution is at 0.50 mL/min. The data is collected at one data point/second.

The CEF column is packed with glass beads at 125 μm±6% (MO-SCI Specialty Products) with ⅛ inch stainless tubing. Glass beads are acid washed by MO-SCI Specialty. Column volume is 2.06 mL. Column temperature calibration is performed by using a mixture of NIST Standard Reference Material Linear polyethylene 1475a (1.0 mg/mL) and Eicosane (2 mg/mL) in ODCB. Temperature is calibrated by adjusting elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0 mg/mL) and hexacontane (Fluka, purum, ≧97.0%, 1 mg/mL). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined in Equation 12, as shown in FIG. 12, where the column resolution is 6.0.

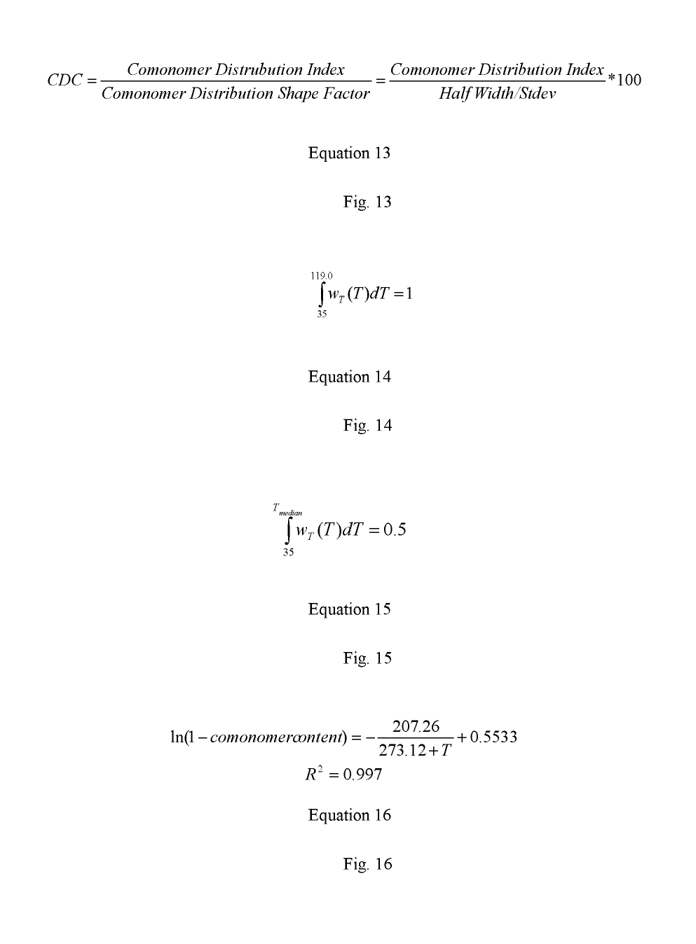

The comonomer distribution constant (CDC) may then be calculated from the CEF comonomer distribution profile. CDC is defined as Comonomer Distribution Index divided by Comonomer Distribution Shape Factor multiplying by 100 as shown in Equation 13, FIG. 13.

Comonomer distribution index stands for the total weight fraction of polymer chains with the comonomer content ranging from 0.5 of median comonomer content (C_{median}) and 1.5 of C_{median} from 35.0 to 119.0° C. Comonomer Distribution Shape Factor is defined as a ratio of the half width of comonomer distribution profile divided by the standard deviation of comonomer distribution profile from the peak temperature (Tₚ).

CDC is calculated from comonomer distribution profile by CEF, and CDC is defined as Comonomer Distribution Index divided by Comonomer Distribution Shape Factor multiplying by 100 as shown in Equation 13, FIG. 13, and wherein Comonomer distribution index stands for the total weight fraction of polymer chains with the comonomer content ranging from 0.5 of median comonomer content (C_{median}) and 1.5 of C_{median} from 35.0 to 119.0° C., and wherein Comonomer Distribution Shape Factor is defined as a ratio of the half width of comonomer distribution profile divided by the standard deviation of comonomer distribution profile from the peak temperature (Tp).

CDC is calculated according to the following steps:

(A) Obtain a weight fraction at each temperature (T) (w_{T}(T)) from 35.0° C. to 119.0° C. with a temperature step increase of 0.200° C. from CEF according to Equation 14, as shown in FIG. 14;

(B) Calculate the median temperature (T_{median}) at cumulative weight fraction of 0.500, according to Equation 15, as shown in FIG. 15;

(C) Calculate the corresponding median comonomer content in mole % (C_{median}) at the median temperature (T_{median}) by using comonomer content calibration curve according to Equation 16, as shown in FIG. 16;

(D) Construct a comonomer content calibration curve by using a series of reference materials with known amount of comonomer content, i.e., eleven reference materials with narrow comonomer distribution (mono-modal comonomer distribution in CEF from 35.0 to 119.0° C.) with weight average Mw of 35,000 to 115,000 (measured via conventional GPC) at a comonomer content ranging from 0.0 mol % to 7.0 mol % are analyzed with CEF at the same experimental conditions specified in CEF experimental sections;

(E) Calculate comonomer content calibration by using the peak temperature (Tₚ) of each reference material and its comonomer content; The calibration is calculated from each reference material as shown in Formula 16, FIG. 16, wherein: R² is the correlation constant;

(F) Calculate Comonomer Distribution Index from the total weight fraction with a comonomer content ranging from 0.5*C_{median} to 1.5*C_{median}, and if T_{median} is higher than 98.0° C., Comonomer Distribution Index is defined as 0.95;

(G) Obtain Maximum peak height from CEF comonomer distribution profile by searching each data point for the highest peak from 35.0° C. to 119.0° C. (if the two peaks are identical, then the lower temperature peak is selected); half width is defined as the temperature difference between the front temperature and the rear temperature at the half of the maximum peak height, the front temperature at the half of the maximum peak is searched forward from 35.0° C., while the rear temperature at the half of the maximum peak is searched backward from 119.0° C., in the case of a well defined bimodal distribution where the difference in the peak temperatures is equal to or greater than the 1.1 times of the sum of half width of each peak, the half width of the inventive ethylene-based polymer composition is calculated as the arithmetic average of the half width of each peak; and

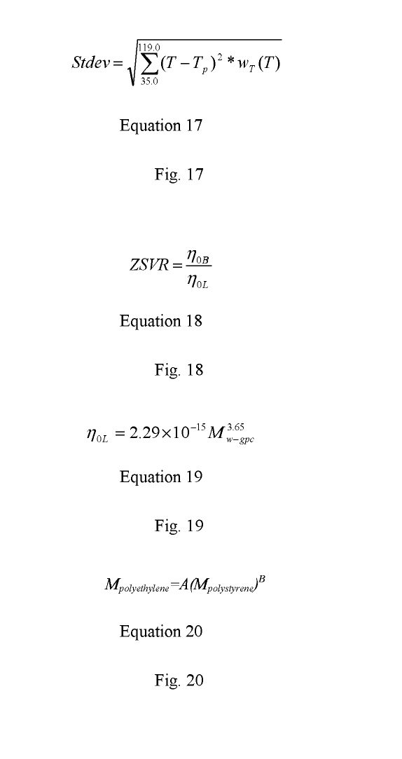

(H) Calculate the standard deviation of temperature (Stdev) according Equation 17, as shown in FIG. 17.

### Zero-Shear Viscosity

Zero-shear viscosities are obtained via creep tests that are conducted on an AR-G2 stress controlled rheometer (TA Instruments; New Castle, Del) using 25-mm-diameter parallel plates at 190° C. The rheometer oven is set to test temperature for at least 30 minutes prior to zeroing fixtures. At the testing temperature a compression molded sample disk is inserted between the plates and allowed to come to equilibrium for 5 minutes. The upper plate is then lowered down to 50 μm above the desired testing gap (1.5 mm). Any superfluous material is trimmed off and the upper plate is lowered to the desired gap. Measurements are done under nitrogen purging at a flow rate of 5 L/min. Default creep time is set for 2 hours.

A constant low shear stress of 20 Pa is applied for all of the samples to ensure that the steady state shear rate is low enough to be in the Newtonian region. The resulting steady state shear rates are in the order of 10⁻³ per second (s⁻¹) for the samples in this study. Steady state is determined by taking a linear regression for all the data in the last 10% time window of the plot of log(J(t)) versus log(t), where J(t) is creep compliance and t is creep time. If the slope of the linear regression is greater than 0.97, steady state is considered to be reached, then the creep test is stopped. In all cases in this study the slope meets the criterion within 30 minutes. The steady state shear rate is determined from the slope of the linear regression of all of the data points in the last 10% time window of the plot of ε versus t, where ε is strain. The zero-shear viscosity is determined from the ratio of the applied stress to the steady state shear rate.

In order to determine if the sample is degraded during the creep test, a small amplitude oscillatory shear test is conducted before and after the creep test on the same specimen from 0.1 to 100 rad/s. The complex viscosity values of the two tests are compared. If the difference of the viscosity values at 0.1 rad/s is greater than 5%, the sample is considered to have degraded during the creep test, and the result is discarded.

### Zero-Shear Viscosity Ratio

Zero-shear viscosity ratio (ZSVR) is defined as the ratio of the zero-shear viscosity (ZSV) of the inventive polymer to the ZSV of a linear polyethylene material at the equivalent weight average molecular weight (M_{w-gpc}) as shown in the Equation 18, as shown in FIG. 18.

The η₀ value (in Pa·s) is obtained from creep test at 190° C. via the method described above. It is known that ZSV of linear polyethylene η_{0L} has a power law dependence on its M_{w} when the M_{w} is above the critical molecular weight M_{c}. An example of such a relationship is described in Karjala et al. (Annual Technical Conference—Society of Plastics Engineers (2008), 66^{th}, 887-891) as shown in the Equation 19, as shown in FIG. 19, to calculate the ZSVR values.

Referring to Equation 19, as showing in FIG. 19, M_{w-gpc} value (g/mol) is determined by using the GPC method as defined immediately hereinbelow.

To obtain M_{w-gpc} values, the chromatographic system consist of either a Polymer Laboratories Model PL-210 or a Polymer Laboratories Model PL-220. The column and carousel compartments are operated at 140° C. Three Polymer Laboratories 10-μm Mixed-B columns are used with a solvent of 1,2,4-trichlorobenzene. The samples are prepared at a concentration of 0.1 g of polymer in 50 mL of solvent. The solvent used to prepare the samples contain 200 ppm of the antioxidant butylated hydroxytoluene (BHT). Samples are prepared by agitating lightly for 4 hours at 160° C. The injection volume used is 100 μL and the flow rate is 1.0 mL/min. Calibration of the GPC column set is performed with twenty one narrow molecular weight distribution polystyrene standards purchased from Polymer Laboratories. The polystyrene standard peak molecular weights are converted to polyethylene molecular weights using Equation 20, as shown in FIG. 20.

Referring to Equation 20, as shown in FIG. 20, M is the molecular weight, A has a value of 0.4316 and B is equal to 1.0. A third order polynomial is determined to build the logarithmic molecular weight calibration as a function of elution volume. Polyethylene equivalent molecular weight calculations are performed using Viscotek TriSEC software Version 3.0. The precision of the weight-average molecular weight ΔM_{w} is excellent at <2.6%.

### Unsaturation

Unsaturation may be determined by two methods, both requiring use of a proton-nuclear magnetic resonance (¹H NMR) approach. To carry out this type of testing, 3.26 g of stock solution is added to 0.133 g of polyolefin sample in 10 mm NMR tube. The stock solution is a mixture of tetrachloroethane-d₂ (TCE) and perchloroethylene (50:50, w:w) with 0.001M Cr³⁺. The solution in the tube is purged with N₂ for 5 minutes to reduce the amount of oxygen. The capped sample tube is left at room temperature overnight to swell the polymer sample. The sample is dissolved at 110° C. with shaking. The samples are free of the additives that may contribute to unsaturation, e.g. slip agents such as erucamide.

The ¹H NMR are run with a 10 mm cryoprobe at 120° C. on Bruker AVANCE 400 MHz spectrometer.

Two experiments are run to get the unsaturation: the control and the double presaturation experiments.

For the control experiment, the data is processed with exponential window function with LB=1 Hz, baseline was corrected from 7 to −2 ppm. The signal from residual ¹H of TCE is set to 100, the integral Iₜₒₜₐₗ from −0.5 to 3 ppm is used as the signal from whole polymer in the control experiment. The number of CH₂ group, NCH₂, in the polymer is calculated as following:

NCH₂═Iₜₒₜₐₗ/2

For the double presaturation experiment, the data is processed with exponential window function with LB=1 Hz, baseline was corrected from 6.6 to 4.5 ppm. The signal from residual ₁H of TCE is set to 100, the corresponding integrals for unsaturations (I_{vinylene}, I_{trisubstituted}, I_{vinyl} and I_{vinylidene}) were integrated based on the region shown in FIG. 21. The number of unsaturation unit for vinylene, trisubstituted, vinyl and vinylidene are calculated:

N_{vinylene}═I_{vinylene}/2

N_{trisubstituted}═I_{trisubstitute}

N_{vinyl}═I_{vinyl}/2

N_{vinylidene}═I_{vinylidene}/2

The unsaturation unit/1,000,000 carbons is calculated as following:

N_{vinylene}/1,000,000C═(N_{vinylene}/NCH₂)*1,000,000

N_{trisubstituted}/1,000,000C═(N_{trisubstituted}/NCH₂)*1,000,000

N_{vinyl}/1,000,000C═(N_{vinyl}/NCH₂)*1,000,000

N_{vinylidene}/1,000,000C═(N_{vinylidene}/NCH₂)*1,000,000

The requirement for unsaturation NMR analysis includes: level of quantitation is 0.47±0.02/1,000,000 carbons for Vd2 with 200 scans (less than 1 hour data acquisition including time to run the control experiment) with 3.9 wt % of sample (for Vd2 structure, see Macromolecules, vol. 38, 6988, 2005), 10 mm high temperature cryoprobe. The level of quantitation is defined as signal to noise ratio of 10.

The chemical shift reference is set at 6.0 ppm for the ¹H signal from residual proton from TCT-d2. The control is run with ZG pulse, TD 32768, NS 4, DS 12, SWH 10,000 Hz, AQ 1.64 s, D1 14 s. The double presaturation experiment is run with a modified pulse sequence, O1P 1.354 ppm, O2P 0.960 ppm, PL9 57db, PL21 70 db, TD 32768, NS 200, DS 4, SWH 10,000 Hz, AQ 1.64 s, D1 1 s, D13 13 s. The modified pulse sequences for unsaturation with Bruker AVANCE 400 MHz spectrometer are shown in FIG. 22.

### Examples (Ex.) 1-3 and Comparative Examples (CEx.) A-D

A variety of foamable formulations, designated as Examples 1-3 and Comparative Examples A-D, are prepared including the materials listed hereinbelow. The constituency of the formulations is shown in Table 4.
Resin 1 is GMH GH051, a conventional metallocene-catalyzed linear low density polyethylene (mLLDPE) resin produced by Sumitomo Chemicals (MI: 0.4 g/10 min, D: 0.921 g/cm³).
Resin 2 is an ELITE AT (enhanced polyethylene, EPE) resin from The Chemical Company (MI: 1.5 g/10 min, D: 0.912 g/cm³).
Resin 3 is an ELITE AT (EPE) resin from The Dow Chemical Company (MI: 0.8 g/10 min, D; 0.905 g/cm³).
Resin 4 is ENGAGE 8480, a conventional polyolefin resin from The Dow Chemical Company (MI: 1.0 g/10 min, D: 0.902 g/cm³).
Resin 5 is ELVAX 460, an EVA resin from E.I. du Pont de Nemours, Inc., having a vinyl acetate content of 18% by weight.
Resin 6 is EVOLUE 2040, a conventional mLLDPE resin from Prime Polymers (MI: 3.8 g/10 min), D: 0.918 g/cm³).
Resin 7 is EVOLUE 1540, a conventional mLLDPE resin from Prime Polymers (MI: 3.8 g/10 min, D: 0.913 g/cm³).
CaCO₃ is calcium carbonate, used as a nucleation agent and filler.
ST is stearic acid, used as a processing aid.
DCP is dicumyl peroxide, 100% active, used as a cross link agent.
AA100 is azobisformamide, used as a blowing agent.

TABLE 4

| | CEx. A | Ex. 1 | Ex. 2 | CEx. B | Ex. 3 | CEx. C | CEx. D |
|---|---|---|---|---|---|---|---|
| Resin 1 | 100 | — | — | — | — | — | — |
| Resin 2 | — | 100 | — | — | 33 | — | — |
| Resin 3 | — | — | 100 | — | — | — | — |
| Resin 4 | — | — | — | 100 | — | — | — |
| Resin 5 | — | — | — | — | 67 | 67 | 67 |
| Resin 6 | — | — | — | — | — | 33 | — |
| Resin 7 | — | — | — | — | — — | — | 33 |
| CaCO₃ | 10 | 10 | 10 | 10 | — | — | — |
| ST | 0.5 | 0.5 | 0.5 | 0.5 | 0.6 | 0.6 | 0.6 |
| ZnO | 1.5 | 2.5 | 2.5 | 2.5 | 1 | 1 | 1 |
| DCP | 0.8 | 0.8 | 0.8 | 0.8 | 0.9 | 0.9 | 0.9 |
| AAS100 | 2.5 | 2.0 | 2.3 | 3.0 | 3.l8 | 3.8 | 3.8 |

All amounts are parts per hundred parts, based upon formulation as a whole.

Compounding conditions include a total batch size that is 10 times the amount of the total resin or resins, designated as Resins 1 through 7. Compounding is done at a temperature from 125° C. to 130° C. for formulations including Resin 2 or Resin 3, and from 100° C. to 110° C. for the remaining foams. Compounding steps for each formulation include pouring the resins into a two-roll mill and blending until each or all resins included in that formulation are completely melted and homogeneous. The additives are then added slowly into the mill, with the blowing agent, blowing agent activator, and cross link agent being the last additives put into the formulation.

In order to form the foam buns, the fully homogeneous compound is sheeted out to a thickness of about 5 millimeters (mm) and then cut and weighed for molding. Total mixing time ranges from 12 to 15 minutes.

Molding dimension is 140 mm×140 mm×8 mm. Sample weight is 200±5 g (about 5 plies). Molding temperature is 170° C., and time is 8 minutes.

Sample testing is carried out based upon the methods shown in Table 5.

TABLE 5

| Property | Method |
|---|---|
| Specific Gravity | ASTM D297 |
| Foam Hardness (Type C) | ASTM2240 |
| Compression Set | ASTM D395, at 50° C., 50% for |
| | 6 hours, measured after specified |
| | recovery time (30 min or 24 h) |
| Tensile Strength | ASTM D412 |
| Elongation | ASTM D412 |
| Tear Strength | ASTM D624 |
| Split Tear | BS 5131 |
| Resilience | ASTM D2632 |

In addition to the tests shown in Table 5, shrinkage is tested at 70° C. by drawing two lines with a length of 10 cm diagonally on the foam specimen, which measures 10 cm by 10 cm by 10 mm, and then placing the specimens in an oven at 70° C. for 40 minutes. The foams are then taken out of the oven, and placed on a rack to cool under constant humidity and temperature (23° C., 50% relative humidity) for 30 minutes. The lines are measured again, and the following determines the shrinkage: Shrinkage (%)=(initial length−final length)/(initial length)×100%.

The properties test results are shown in Table 6.

TABLE 6

| Property | CEx. A | Ex. 1 | Ex. 2 | CEx. B |
|---|---|---|---|---|
| Expansion Factor, | 1.81 | 1.84 | 1.82 | 1.81 |
| before cooling | | | | |
| Expansion Factor, | 1.68 | 1.72 | 1.70 | 1.72 |
| after cooling | | | | |
| Specific Gravity, | 0.176 | 0.17 | 0.187 | 0.178 |
| with skin | | | | |
| Specific Gravity, | 0.161 | 0.162 | 0.173 | 0.164 |
| without skin | | | | |
| Hardness, Type C, | 68 ± 1 | 62 ± 1 | 60 ± 1 | 59 ± 1 |
| with skin | | | | |
| Hardness, Type C, | 59 ± 1 | 56 ± 1 | 55 ± 1 | 52 ± 1 |
| without skin | | | | |
| Tensile Strength, | 35.6 | 30.9 | 35.1 | 38.1 |
| kg/cm2 | | | | |
| Elongation, % | 242 | 306 | 12 | 276 |
| Tear Strength, | 12.6 | 12.6 | 13.1 | 12.0 |
| kg/cm | | | | |
| Split Tear, k/cm | 3.0 | 4.3 | 4.4 | 3.0 |
| Compression | 35.2 | 30.7 | 28.4 | 34.9 |
| Set, %, after 30 | | | | |
| min | | | | |
| Compression | 34.5 | 29.0 | 26.5 | 33.7 |
| Set, %, after 24 h | | | | |
| Resilience, % | 34 | 33 | 36 | 38 |
| Shrinkage, % | 0.5 | 0.5 | 0.5 | 1.0 |

The properties tests show that, in comparison with foams based on an mLLDPE resin (CEx. A), the inventive foams have lower hardness, better (i.e., lower value) compression set and split tear, and similar shrinkage percentage. Compared to a POE-based foam (CEx. B), the inventive exhibits similar hardness and better compression set, split tear, and shrinkage percentage.

### Example 2

The remaining foams, designated as Example 3 and Comparative Examples C and D, are tested for properties, with the results shown in Table 7.

TABLE 7

| Property | Ex. 3 | CEx. C | CEx. D |
|---|---|---|---|
| Specific Gravity, g/cm3 | 0.151 | 0.136 | 0.155 |
| Hardness, Type C | 52-53 | 52-53 | 51-52 |
| Tensile Stength, kg/cm2 | 21.19 | 19.2 | 25.74 |
| Elongation, % | 333 | 300 | 366 |
| Tear, kg/cm | 15.12 | 13.67 | 16.26 |
| Split Tear, kg/cm | 2.43 | 2.3 | 2.5 |
| Compression Set, % | 70.75 | 73.16 | 73.49 |
| Resilience, % | 40-41 | 38-39 | 40 |
| Shrinkage, % | 0 | 0 | 0 |

Table 7 shows that all three foams exhibited relatively similar hardness, but Ex. 5 affords better compression set than CEx. 6 and CEx. 7, which are based on metallocene catalyzed hexane LLDPE resins.

What is claimed is:

1. A foamable formulation composition comprising at least 50 weight percent (wt %), based on the formulation as a whole, of an ethylene/α-olefin interpolymer composition (LLDPE) having a Comonomer Distribution Constant (CDC) ranging from 75 to 200, a vinyl unsaturation of less than 0.15 vinyls per one thousand carbon atoms present in the backbone of the ethylene-based polymer composition; a zero shear viscosity ratio (ZSVR) ranging from 2 to 20; a density ranging from 0.903 to 0.950 g/cm3; a melt index (I2) ranging from 0.1 to 5 g/10 minutes; and a molecular weight distribution (Mw/Mn) ranging from 1.8 to 3.5.

2. The foamable formulation composition of claim 1 further comprising up to 50 weight percent of at least one additional polymer is selected from the group consisting of poly(styrene-ethylene/butylene-styrene) (SEBS) polymers; poly(styrene-butadiene-styrene) (SBS) polymers; poly(styrene-ethylene/propylene-styrene) (SEPS) polymers; ethylene-butene copolymers; ethylene-octene copolymers; ethylene-hexene copolymers; ethylene-propylene-rubber (EPR) polymers; ethylene-propylene-diene-monomer (EPDM) polymers; ethylene vinyl acetate (EVA) polymers; propylene-ethylene copolymers; ethylene co-acrylic acid (EAA) polymers; ethylene e??? acetate (EEA) polymers; ethylene methacrylate (EMA) polymers; ethylene-bis-stearamide (EBS) polymers; polyolefin elastomer (POE) polymers; polyethylene/ethylene copolymers; low density polyethylene polymers; and combinations thereof.

3. The foamable formulation of claim 1 further comprising a blowing agent, a cross link agent, or a combination thereof.

4. A process for preparing a foamed composition comprising
(a) preparing a foamable formulation composition comprising at least 50 weight percent, based on the formulation as a whole, of an ethylene/α-olefin interpolymer composition (LLDPE) having a Comonomer Distribution Constant (CDC) ranging from 75 to 200, a vinyl unsaturation of less than 0.15 vinyls per one thousand carbon atoms present in the backbone of the ethylene-based polymer composition; a zero shear viscosity ratio (ZSVR) ranging from 2 to 20; a density ranging from 0.903 to 0.950 g/cm3; a melt index (I2) ranging from 0.1 to 5 g/10 minutes; and a molecular weight distribution (Mw/Mn) ranging from 1.8 to 3.5; and
(b) subjecting the foamable formulation of step (a) to conditions such that a foamed composition is formed.

5. The process wherein the foamed composition of claim 4 has a density ranging from 0.05 to 0.25 grams per cubic centimeter.

6. The foamed composition prepared by the process of claim 3.

7. The foamed composition of claim 6 having a property selected from the group consisting of compression set, according to ASTM D395; split tear, according to BS 5131; shrinkage percentage; and combinations thereof; that is lower, with respect to compression set or shrinkage, or higher, with respect to split tear strength, when compared with that of a foam that is prepared from an otherwise identical formulation that lacks the at least 50 weight percent, based on the formulation as a whole, of the ethylene/α-olefin interpolymer.
